(19) United States
(12) Patent Application Publication
(10) Pub. No.: US 2003/0132592 A1
(43) Pub. Date: Jul. 17, 2003

(54) All terrain trick scooter

(76) Inventor: Raymond Jay Dombroski, Manhattan Beach, CA (US)

Correspondence Address: RAYMOND DOMBROSKI, 214 KELP ST., MANHATTAN BEACH, CA, 90266, US

(21) Appl. No.: 10/145,501

(22) Filed: May 14, 2002

Related U.S. Application Data
(60) Provisional application No. 60/291,456, filed on May 15, 2001.

(51) Int. Cl. B62M 1/00

(52) U.S. Cl. 280/87.01

(57) ABSTRACT

In accordance with the present invention, an all-terrain trick scooter comprises an upright head tube, a main tube extending downward from said head tube, two rear fork arms extending out from the lower end of said main tube, a pair of rear axle seats attached to each said rear fork arms, a pair of rear foot pegs extending out laterally from the lower end of said frame, a rear wheel connected to said rear axle seats, a front fork including a fork shaft and two prongs extending downwardly therefrom, a pair of front axle seats attached to the lower end of said prongs, a pair of front foot pegs extending out laterally from said front axle seats, a front wheel connectable to said front axle seats, a handlebar connectable to said fork shaft of said front fork, a means of braking utilizing hand brakes coupled to said handlebars.

### BACKGROUND

1. Field of Invention

This invention relates to a scooter, and more particularly pertains to a two-wheeled scooter for all terrain use and trick-riding.

2. Description of Prior Art

A standard scooter is a vehicle consisting of a longitudinal footboard supported by front and rear wheels and controlled by an upright steering post coupled to the front wheel and provided with a steering handle. A person riding the scooter grasps the handle, with one foot resting on the footboard. The person puts the scooter in motion by means of his other foot which makes pushing contact with the road on one side of the footboard.

A standard scooter is generally not a suitable all terrain vehicle because the footboard has a low ground clearance, and will tend to come into contact with raised terrain elements, such as rocks, stairs, curbs, road potholes, exposed tree roots, and pavement cracks. If there is substantial friction between the terrain and the bottom of the footboard, the scooter may abruptly stop and throw the rider. U.S. Pat. No. 6,012,539 to Patmont (2000) and U.S. Pat. No. 5,470,089 to Whitson (1995) disclose scooters which utilize pneumatic bicycle-type tires, which are more suited for off-road riding. But the ground clearance between the tires is still limited by the height of the foot platforms or frame components.

U.S. Pat. No. 5,620,189 to Hinderhofer (1997) and U.S. Pat. No. 5,785,331 to Rappaport (1998) disclose scooters which have both substantially large front wheels in combination with much smaller rear wheels. The large front wheel serves to enhance steering control, especially over uneven terrain. The rear wheels are small, so as not to interfere with the rider's feet during operation of the scooter. These scooters have a disadvantage on rough terrain, because the small rear wheels may not be able to roll over larger obstacles.

A disadvantage of scooters disclosed in U.S. Pat. No. 1,689,916 to Fisher (1928), U.S. Pat. No. 4,394,029 to Holmgren (1983), U.S. Pat. No. 6,012,539 to Patmont (2000), and U.S. Pat. No. 5,470,089 to Whitson (1995) is the difficulty presented in attempting a maneuver in which the rider lifts the front wheel off the riding surface, commonly referred to as a “wheelie.” This type of maneuver is useful both as a means of clearing a large obstacle, and also as a recreational trick maneuver. The rider of a standard scooter will rest his foot on the footboard, which will tend to spread the rider's weight distribution equally between the front and rear wheels. This makes it difficult for the rider to raise the front wheel for an extended period of time.

### OBJECTIVES AND ADVANTAGES

Accordingly, besides the objects and advantages of the scooters described in my above patent, several objects and advantages of the present invention are:

(a) to provide a scooter which has enough ground clearance to be ridden over common off-road and street obstacles, such as curbs, stairs, road potholes, exposed tree roots, and pavement cracks;

(b) to provide a scooter whose frame geometry makes it easy to perform wheelie stunts;

(c) to provide a scooter which has a lightweight frame. Thus improving the trick riding capability of the scooter, as well as reducing shipping costs;

(d) to provide a scooter whose frame construction requires a minimum number of components, as well as a minimum amount of welding and bending of those components, thus reducing construction costs;

(e) to provide a scooter which offers the rider multiple options for standing position;

(f) to provide a scooter which uses common bicycle components, providing users a means for easy and economical repair.

### DRAWING FIGURES

FIG. 1 is a perspective view of the preferred embodiment of the scooter constructed in accordance with the principles of the present invention.

FIG. 2 is a side view of the preferred embodiment of the scooter in FIG. 1.

FIG. 3 is a front view of the preferred embodiment of the scooter in FIG. 1.

FIG. 4 is a upper view of the preferred embodiment of the scooter in FIG. 1

FIG. 5 is an alternative embodiment of the rear foot peg configuration.

REFERENCE NUMERALS IN DRAWINGS

| | | | |
|---|---|---|---|
| 1 | frame | 8 | fork shaft |
| 2 | head tube | 9L | left prong |
| 3 | main tube | 9R | right prong |
| 4L | left fork arm | 10L | left front axle seat |
| 4R | right fork arm | 10R | right front axle seat |
| 5L | left rear axle seat | 11 | front wheel |
| 5R | right rear axle seat | 12 | handlebars |
| 6 | rear wheel | 13L | left handbrake |
| 7 | front fork | 13R | right handbrake |
| 14L | front left foot peg | 15L | rear left foot peg |
| 14R | front right foot peg | 15R | rear right foot peg |
| 16 | scooter | 17R | right rear peg bracket |
| 17L | left rear peg bracket | 18 | rear peg bracket support brac |

DESCRIPTION

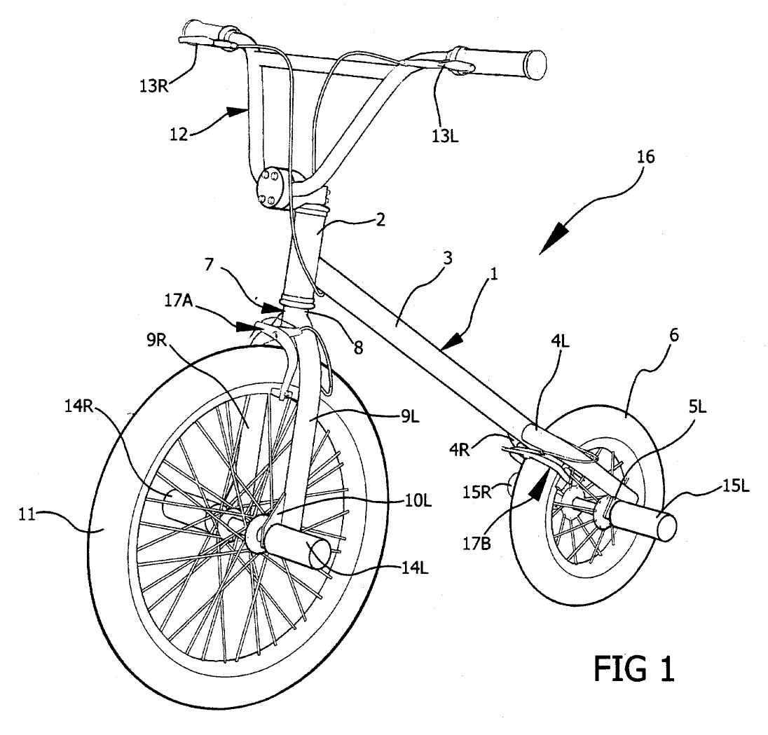

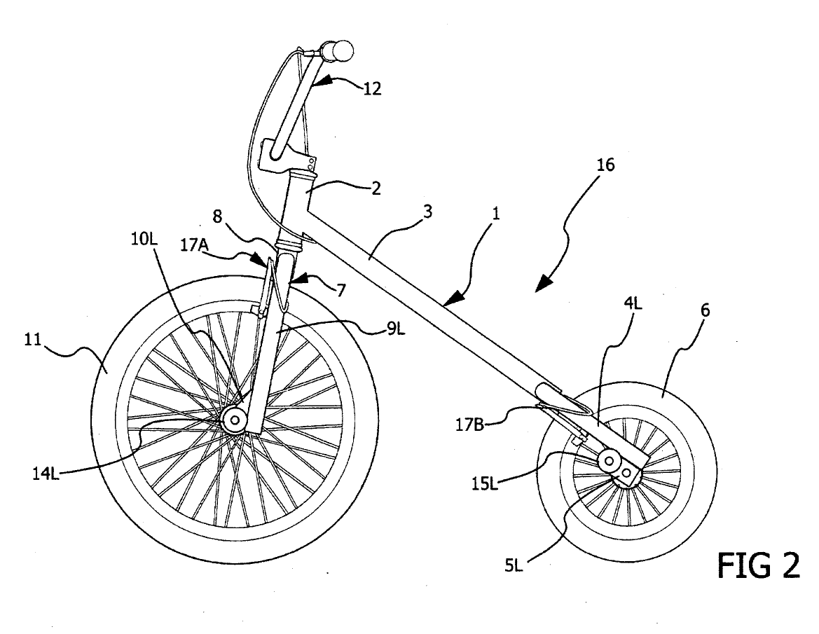

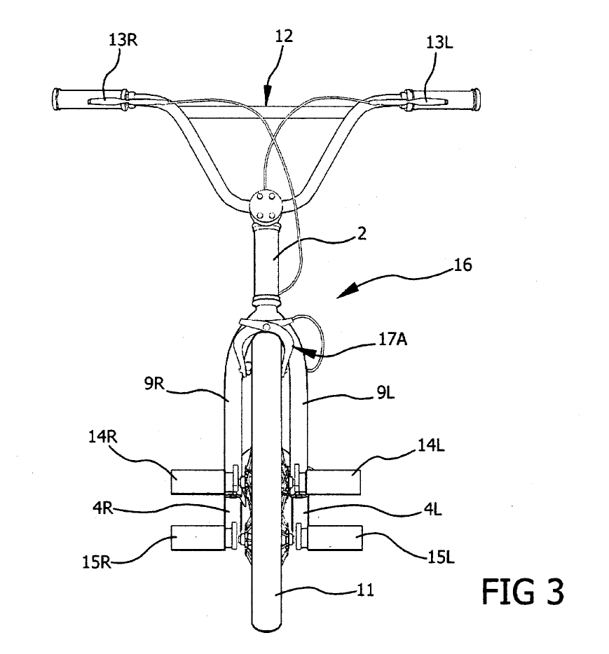

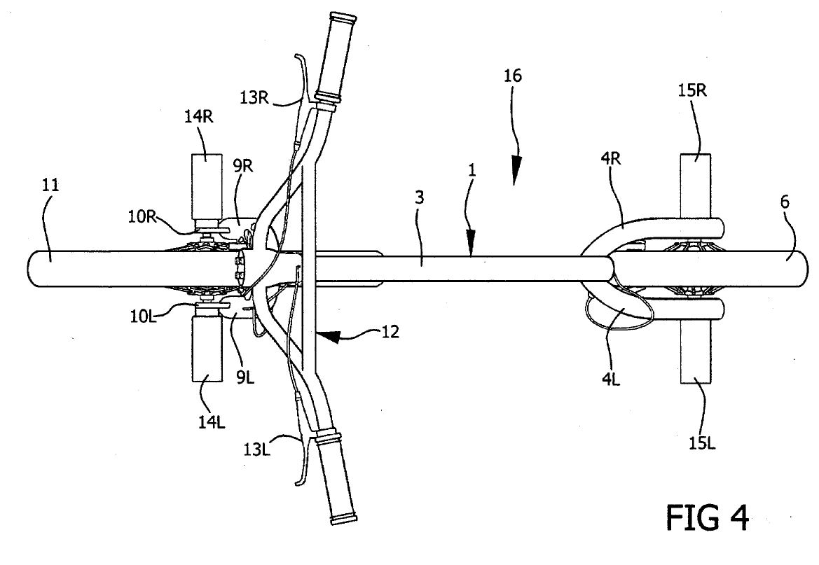

FIG 1-4—Preferred Embodiment

FIG. 1 is a perspective view of the scooter 16. The scooter includes a frame 1. The frame 1 includes a Head Tube 2. Extending downward from the head tube 2 is a main tube 3. Two rear fork arms 4L and 4R extend out from the lower end of the main tube 3. A right rear axle seat 5R is connected to the right rear fork arm 4R. A left rear axle seat 5L is connected to the left rear fork arm 4L. The scooter includes a rear wheel 6, which is mounted between the left rear axle seat 5L and the right rear axle seat 5R. In the preferred embodiment, the rear wheel 6 is a standard 12-inch bicycle wheel. A rear left foot peg 15L extends outwards laterally from the left rear axle seat 5L. A rear right foot peg 15R extends outwards laterally from the right rear axle seat 5R

The scooter includes a front fork 7. The front fork 7 includes a fork shaft 8 with two spaced prongs 9L and 9R extending downwardly therefrom. Each prong 9L and 9R defines a front axle seat 10L and 11R to secure a front wheel 11. A front left foot peg 14L extends outwards laterally from the left front axle seat 10L. A front right foot peg 14R extends outwards laterally from the right front axle seat 10R. In the preferred embodiment, the front wheel is a standard spoked 16-inch to 22-inch bicycle wheel. The fork shaft 8 is disposed within the head tube 2. The front fork 7 is similar to forks used on conventional bicycles.

The scooter includes handlebars 12 which are coupled to the upper end of the fork shaft 8. A left handbrake 13L is attached to the left end of the handlebars 12 and the front fork 7 for applying a braking force to the front wheel 11. A right handbrake 13R is attached to the right end of the handlebars 12 and the frame 1 for applying a braking force to the rear wheel 6. The handlebars 12 and left and right handbrakes 13L and 13R are similar to those used on conventional bicycles, ensuring ease of replacement thereof since these components are readily available at most bicycle repair shops.

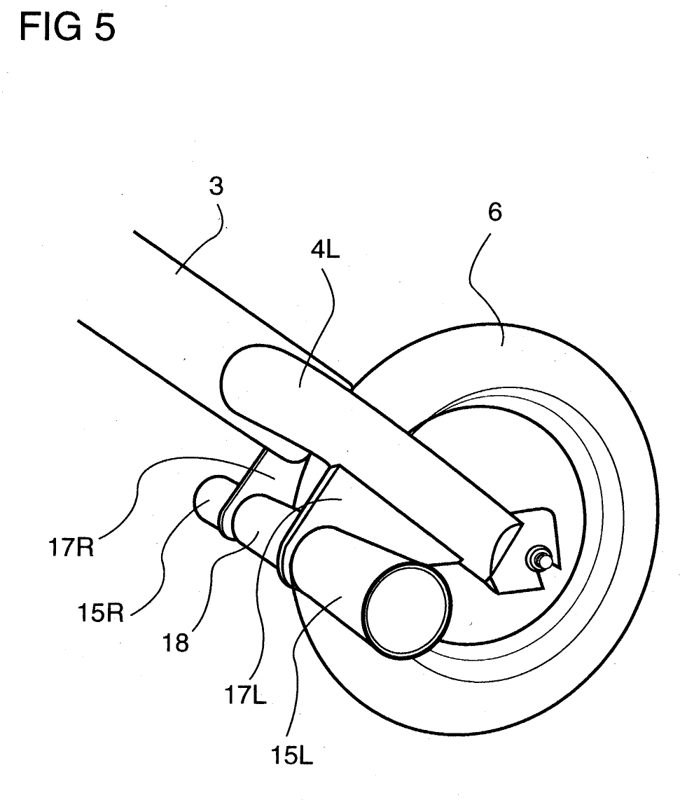

FIG. 5—Alternative Embodiment

There are various possibilities with regard to the mounting position of the rear pegs. To provide a more stable ride for a novice rider, the rear pegs may be mounted further forward on the frame than as shown in FIGS. 1-4. FIG. 5 shows the rear pegs mounted to left and right rear peg brackets 17L and 17R. A rear peg bracket support brace 18 spans the space between the rear peg brackets.

Advantages

From the description above, a number of advantages of my all-terrain trick scooter become evident.

(a) The use of laterally mounted foot pegs instead of a longitudinally mounted footboard allows for a higher ground clearance between the wheels. This allows the scooter to be ridden over rougher terrain than scooters in present use.

(b) The proximity of the rear foot pegs to the rear axle provides more leverage for the rider to lift the front wheel off the riding surface, making it easy for the rider to perform wheelie stunts.

(c) The use of a large front pneumatic wheel, instead of a small wheel, allows for better steering control over uneven terrain.

(d) The use of a smaller pneumatic rear wheel helps the rider avoid unintentional contact between the wheel and the rider's legs while propelling the scooter or performing a trickriding maneuver.

(e) The rider can have multiple combinations of stances on the front and rear foot pegs, allowing a variety of tricks and stunts.

(f) The low number of components results in a lightweight scooter, allowing the rider to more easily perform hops and jumps.

(g) The use of conventional bicycle handlebars, wheels, and brakes allow the rider to have the scooter repaired at any bicycle repair shop.

(h) The use of conventional bicycle brakes, wheels, and handlebars cuts down on the manufacturing cost of this scooter, because low cost versions of these components are readily available.

(i) The low number of frame materials, and the simplicity of its construction provide a scooter, which is of a lower cost to manufacture, with regard to both materials and labor. This accordingly makes available a scooter that is economically available to the public.

Operation

The manner of using the all-terrain trick scooter is different from scooters in present use. Namely, the rider's foot placement differs because of use of foot pegs instead of a foot platform mounted longitudinally to the frame.

Under normal riding conditions, the rider uses one or both hands to pivot the steering wheel to control traveling direction. As in a conventional bicycle, the rider may squeeze the handbrakes in order to slow or stop the scooter. Under normal riding conditions, the rider stands on the rear foot pegs. If the rider desires more in-line stability at high speeds or while riding over rough terrain, he or she can rest one foot on a front peg, and the other foot on a rear foot peg. Either foot can be used to push off the ground in order to propel the scooter.

Other stances and riding positions are possible, and may enhance the number of trick and stunt combinations. One example would be for the rider to maintain steering control with a foot placed on a front foot peg, allowing the rider to remove both hands from the steering wheel.

The existence of front and rear foot pegs allows the rider to perform advanced stunts. For example, the rider may use one or more foot pegs to slide along a raised stationary object, such as a stairway handrail or street curb.

In addition, the rider may choose to perform stunts and tricks similar to those performed on freestyle bicycles. In executing one of these stunts, the scooter can be manipulated so that only one wheel contacts the riding surface, while the other wheel is raised in the air.

Conclusions, Ramifications, and Scope

Accordingly, the reader will see that the all-terrain trick scooter of this invention can be ridden over uneven, obstacle-laden surfaces, because of the scooter's high ground clearance and use of pneumatic bicycle wheels. In addition, the layout of the foot pegs presents versatile combinations of riding stances, as well as the seemingly endless opportunities for stunt riding. Riders can more easily navigate rough terrain, and roll over large obstacles. Riders can perform recreational stunt-riding tricks more easily, as well as accomplish new ones because of the frame layout and the corresponding riding positions. Furthermore, the scooter has additional advantages in that:

it permits steering with the handlebars or the rider's foot on a front foot peg.

it provides a scooter which is lightweight.

it provides a scooter that is economical and relatively simple to manufacture.

Although the description above contains many specifications, these should not be construed as limiting the scope of the invention but as merely providing illustrations of some of the presently preferred embodiments of this invention. For example, the frame tubing can have other shapes, such as oval, square, or triangular; the frame geometry can be molded as a single piece, instead of connected pieces of tubing.

Thus the scope of the invention should be determined by the appended claims and their legal equivalents, rather than by the examples given.

I claim:

1. A scooter having an upright head tube, a main tube extending downward from said head tube, two rear fork arms extending out from the lower end of said main tube, a pair of rear axle seats attached to each said rear fork arms, a pair of rear foot pegs extending out laterally from the lower end of said frame, a rear wheel connected to said rear axle seats, a front fork including a fork shaft and two prongs extending downwardly therefrom, a pair of front axle seats attached to the lower end of said prongs, a pair of front foot pegs extending out laterally from said front axle seats, a front wheel connectable to said front axle seats, a handlebar connectable to said fork shaft of said front fork, a means of braking utilizing hand brakes coupled to said handlebars.
